(19) United States
(12) Patent Application Publication
(10) Pub. No.: US 2004/0189018 A1
(43) Pub. Date: Sep. 30, 2004

(54) Push bar locking mechanism with rapid unlocking

(75) Inventors: Arthur Geringer, Oak Park, CA (US); David Geringer, Camarillo, CA (US); Richard Geringer, Moorpark, CA (US)

Correspondence Address: JAYE G. HEYBL, KOPPEL,JACOBS, PATRICK & HEYBL, Suite 107, 555 St. Charles Drive, Thousand Oaks, CA, 91360, US

(73) Assignee: SECURITY DOOR CONTROLS

(21) Appl. No.: 10/805,456

(22) Filed: Mar. 19, 2004

Related U.S. Application Data
(60) Provisional application No. 60/456,466, filed on Mar. 20, 2003.

(51) Int. Cl. E05C 19/16

(52) U.S. Cl. 292/251.5

(57) ABSTRACT

A push bar locking mechanism for locking and unlocking a door also comprising a push bar arranged integral to a bar frame such that the push bar can be moved relative to the bar frame. An elongated link is integral to the push bar and bar frame and is movable in response to the push bar movement relative to the bar frame. The movement of the elongated link causes a door locking mechanism to move between a locked and unlocked position. An electromagnetic locking mechanism is included that can be changed between an energized and de-energized state by an electrical signal, wherein the electrical locking mechanism generates a magnetic field when energized. An armature is also included in proximity to the electromagnetic locking mechanism and the elongated link. The armature prevents movement of the elongated link when the electromagnetic locking mechanism is energized.

This application claims the benefit of U.S. Provisional Application Serial No. 60/456,466, which was filed on Mar. 20, 2003.

### BACKGROUND OF THE INVENTION

1. Field of the Invention

The present invention relates to door locking mechanisms, and in particular to push bar door mechanisms with rapid unlocking features.

2. Description of the Related Art

Doors, particularly in the commercial environment, are commonly provided with a horizontal push bar that can be activated to unlock and/or open the door. Conventional push bar mechanisms generally comprise a frame mounted on the door, usually at an arm level, with a depressible bar that can be engaged by the hands of a user and pushed to unlock the lock mechanism to allow the door to open. The actual mechanism for causing a pushing movement of the push bar, and the unlocking of the door, is known. There has not been, however, any effective locking mechanism of this type which uses an electromagnetic control to either allow or block operation of the depressible bar.

U.S. Pat. No. 4,826,223, to Geringer et al. discloses an electromagnetic door lock device that comprises an electromagnet, a bracket for holding the electromagnet in a door frame, an electrical conduit for connecting the electromagnet to a power source, an armature magnetically attracted to the electromagnet when the latter is energized, a connector for holding the armature on a door edge in the frame for adjustable movement towards the electromagnet and a lock component for the device. The lock component comprises one or more ledges at the periphery of the electromagnet and/or armature pair projecting towards and engageable with the other(s) of the pair when the armature is magnetically attracted to the energized electromagnet. This occurs when the armature and electromagnetic are in line with each other, and the armature is free to move toward the electromagnet. Unlocking is effected by de-energizing the electromagnet and allowing the armature to retract by gravity or spring action, so that the lock component also moves out of the described engagement. The device is simple, durable and effective.

One of the disadvantages with electromagnetic door locks generally, is the fact that there is frequently residual magnetism from the electromagnetic element which initially prevents a separation of the door from a door frame. This is almost universally true in the case where a magnetic lock mechanism is mounted on a door or a door frame, and co-acts with an armature located on the opposite side of the door or door frame. In other words, because of the residual magnetism, the door does not immediately open when the electromagnetic element is de-energized.

U.S. Pat. No. 5,033,779 to Geringer et al. also discloses an electromagnetic door lock device similar to the lock in U.S. Pat. No. 4,826,223. The device itself comprises an electromagnet in a housing adapted to be connected to the top edge of a door frame, above a door in the frame. The device also includes an armature block connected to the top of the door in a position near the electromagnet. The armature moves between a down inoperative position away from the electromagnet, facilitated by gravity, when the electromagnet is de-energized and an up extended operative position against the underside of the electromagnet housing when the electromagnet is energized. A locking plate connected to the housing has a tab which depends therefrom and abuts the armature when the latter is in the up position to lock the door closed in the door frame. The improvement prevents slow separation of the armature and tab and hesitant unlocking of the door when the electromagnet is de-energized. The lock also includes a separation accelerator that allows the armature to spring away from the electromagnet, along with the force of gravity, for improved operation.

### SUMMARY OF THE INVENTION

One embodiment of a push bar locking mechanism according to the present invention for locking and unlocking a door comprising a push bar movably arranged integral to a bar frame. The push bar can be moved relative to the bar frame to move a door locking mechanism between the locked and unlocked position. An electromagnetic locking mechanism is included integral to said push bar with an electrical conductor provided to apply an electrical signal to the electromagnetic locking mechanism to energize said electromagnetic locking mechanism to prevent the push bar from moving the door locking mechanism to the unlocked position.

Another embodiment of a push bar locking mechanism according to the present invention for locking and unlocking a door also comprises a push bar arranged integral to a bar frame such that the push bar can be moved relative to the bar frame. An elongated link is integral to the push bar and bar frame and is movable in response to the push bar movement relative to the bar frame. The movement of the elongated link causes a door locking mechanism to move between a locked and unlocked position. An electromagnetic locking mechanism is included that can be changed between an energized and de-energized state by an electrical signal, wherein the electrical locking mechanism generates a magnetic field when energized. An armature is also included in proximity to the electromagnetic locking mechanism and the elongated link. The armature prevents movement of the elongated link when the electromagnetic locking mechanism is energized.

One embodiment of a door system according to the present invention comprises a door mounted within a door frame such that the door is movable between an open and closed position within the door frame. A spring biased bolt is integral to the door and movable between an extended and retracted position. A bolt receiver opening is integral to the door frame and arranged to accept the bolt when it is extended from the door, with the bolt and opening cooperating to hold the door in the closed position when the bolt is extended into the opening. A push bar locking mechanism is mounted to the door and is operable to retract the bolt and comprises a push bar arranged integral to a bar frame such that the push bar can be moved relative to the bar frame to retract the bolt. An electromagnetic locking mechanism is integral to the push bar and an electrical conductor applies an electrical signal to the electromagnetic locking mechanism to prevent the push bar from moving the door locking mechanism to the unlocked position.

These and other features and advantages of the invention will be apparent to those skilled in the art from the following detailed description, taken together with the accompanying drawings, in which:

### BRIEF DESCRIPTION OF THE DRAWINGS

FIG. 1 is a perspective view one embodiment of a door according to the present invention having a push bar locking mechanism, and being opened with respect to a door frame;

FIG. 2 is an exploded perspective view of one embodiment of a push bar locking mechanism according to the present invention;

FIG. 3 is a top plan view of one embodiment of internal locking and unlocking components according to the present invention that can be used in the push bar locking mechanism shown in FIG. 2;

FIG. 4 is a top plan view of internal locking and unlocking components of the push bar locking mechanism shown in FIG. 2, including an electromagnetic element;

FIG. 5 is a top plan view of the components shown in FIG. 4, with the electromagnetic element energized;

FIG. 6 is a top plan view of the components shown in FIG. 4, with the electromagnetic element de-energized;

FIG. 7 is another top plan view of the internal locking and unlocking components shown in FIG. 4, showing the details of the locking mechanism when the electromagnetic element is de-energized;

FIG. 8 is a top plan view of the components shown in FIG. 7, showing the details of the locking mechanism when the electromagnetic element is energized; and

FIG. 9 is a top plan view of the components shown in FIG. 8, showing the details of the locking mechanism when the electromagnetic element is de-energized.

### DETAILED DESCRIPTION OF THE INVENTION

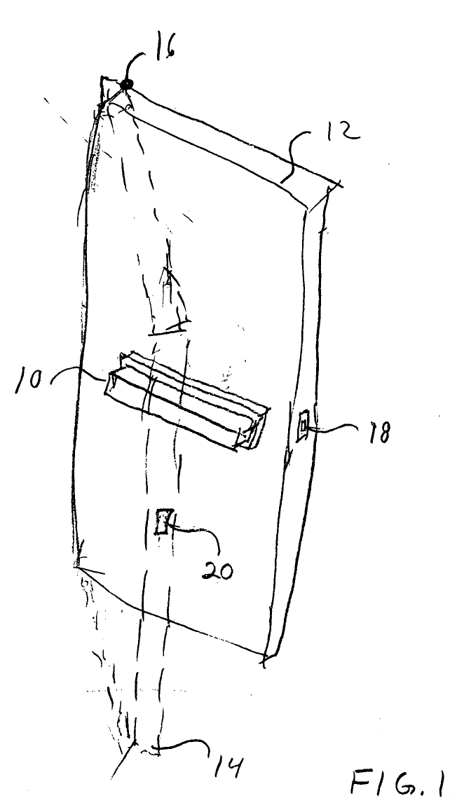

FIG. 1 shows one embodiment of push bar locking mechanism 10 according to the present invention, having an internal electromagnetic element and having improved operation to allow the door to be almost immediately opened after the electromagnetic element is de-energized. The push bar mechanism 10 is mounted horizontally on a conventional door 12 that is then mounted within a door frame 14 by hinges 16 along one of the door's vertical edges so that the door can be easily swung open when the lock mechanism is not engaged. The door 12 of FIG. 1 is shown in the opened position with respect to the door frame 14.

The push bar locking mechanism 10 can be arranged in many different ways to hold the door 12 within the door frame 14 when the mechanism 10 is not actuated and allow the door 12 to swing open when the mechanism is actuated. In the embodiment shown in FIG. 1, the door 12 also comprises a spring biased bolt 18 that is extendable from the door edge under control of the push bar locking mechanism 10. When the bolt 18 is extended it is arranged to mate with a bolt receiving opening 20 in the edge of the door frame to hold the door 12 closed. When the push bar locking mechanism 10 is at rest, the spring biased bolt 18 is typically extended into the opening 20. Actuation of the push bar locking mechanism 10 causes the bolt 18 to retract from the opening to allow the door 12 to open.

It should be understood that the bolt 18 and bolt receiving opening 20 arrangement is known and is shown merely to illustrate one embodiment of how the push bar locking mechanism 10 can function to hold door 12 closed, or to allow a door 12 to open. The push bar locking mechanism 10 can be used in many other arrangements, such as those having a bolt mounted directly to the push-bar locking mechanism. Accordingly, the present invention should not be limited to the embodiment shown.

The push bar locking mechanism 10 comprises an electromagnetic element (described below) that can be energized to block the push bar from opening the door. This can allow for a number of doors to be electrically controlled to allow opening of the doors by the push bar. Alternatively, the electromagnetic element can be arranged to not allow opening of the door until a force is applied to the push bar. In this arrangement the force of the push bar causes the electromagnetic element to allow operation of the push bar to open the door. In both embodiments, the push bar locking mechanism is arranged to allow for near immediate opening of the door, overcoming any delay associated with residual magnetism.

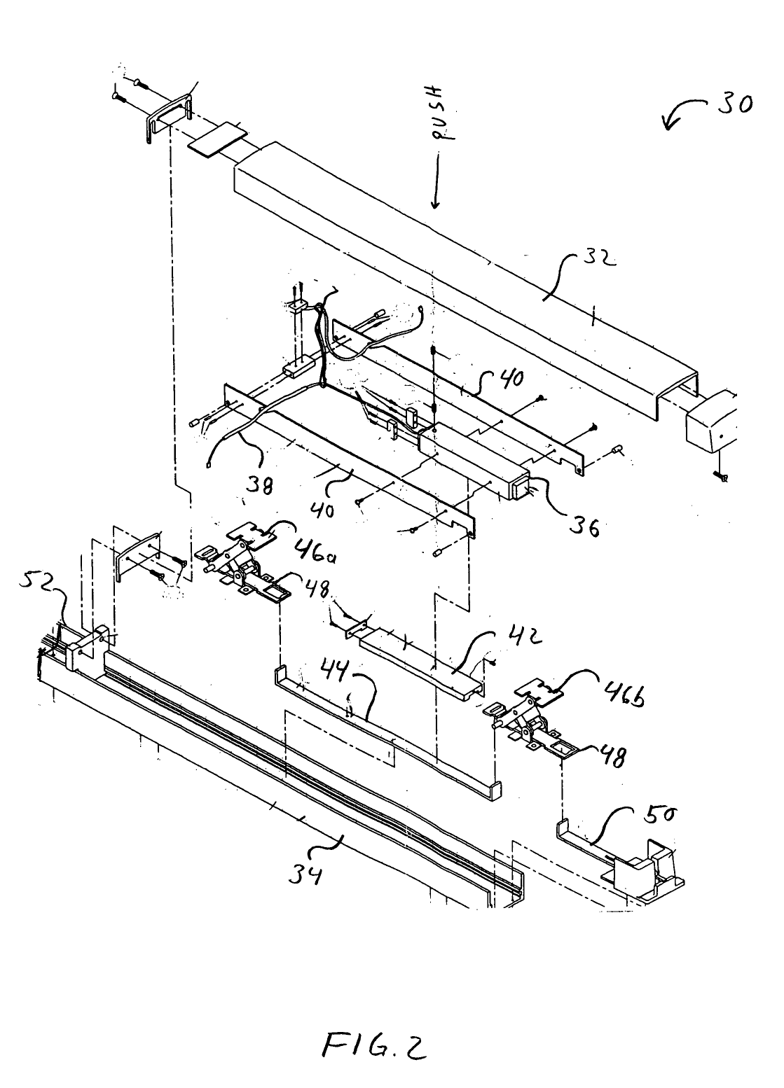

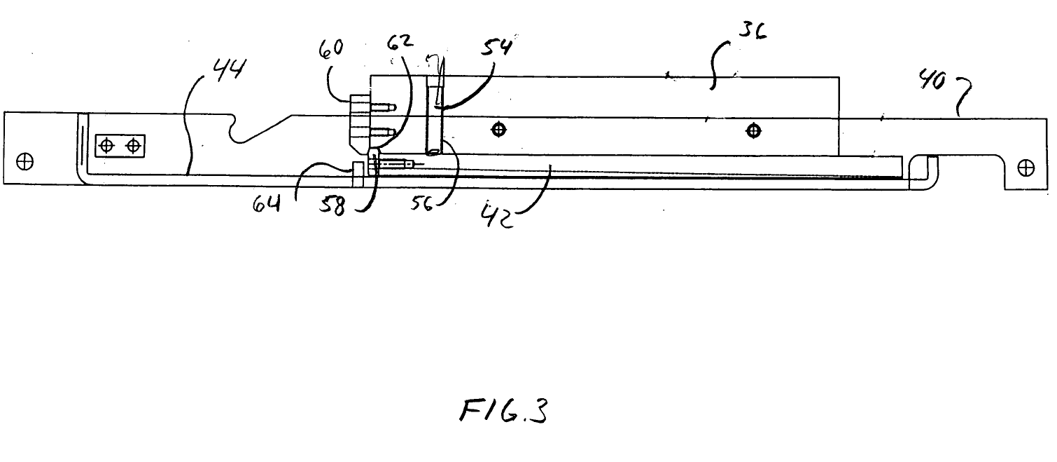

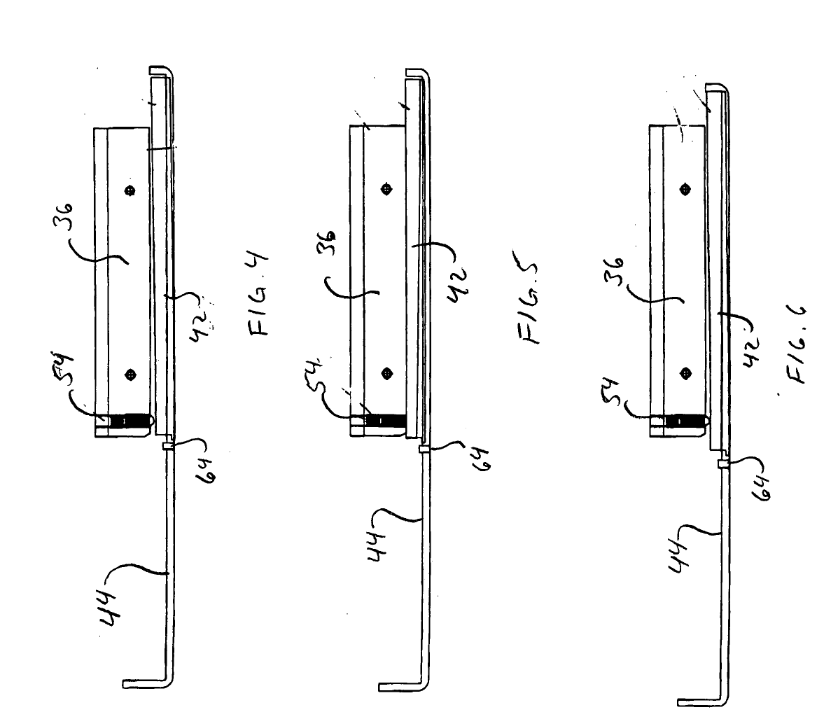

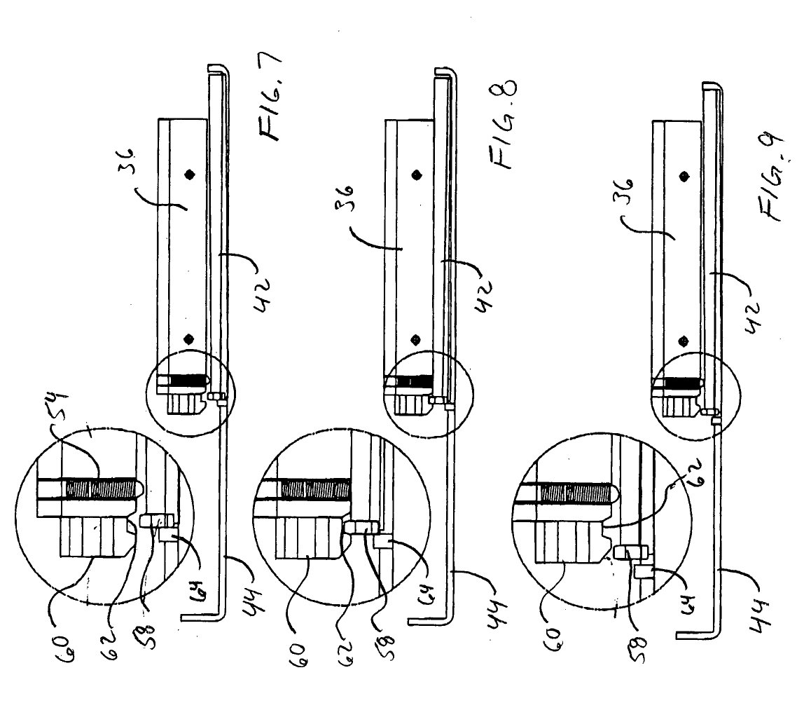

FIG. 2 shows an exploded view of one embodiment of push bar locking mechanism 30 according to the present invention, which generally comprises a push bar 32 which has a U-shaped cross-section and is mounted within a bar frame 34. The bar frame also has a U-shaped cross-section and is sized such that the push bar 32 fits closely within it and can be activated/pushed to move in and out of the bar frame 34. The bar frame is mounted on a door, preferably in the horizontal position and in one embodiment the locking mechanism 30 is coupled to a spring biased bolt as described in FIG. 1.

The push bar locking mechanism 30 comprises a number of internal components pursuant to the present invention. One internal element comprises an electromagnetic locking mechanism 36 that is disposed longitudinally between the bar frame 34 and the push bar 32 and comprises an internal coil (not shown). As more fully described below, the electromagnetic locking mechanism provides for the push bar locking mechanism 30 to respond to an electrical signal to prevent the push bar locking mechanism from opening its respective door. Coils are generally known in the art and are only briefly discussed herein. An electrical conductor 38 is arranged to apply an electrical signal to energize the coil. When the coil is energized a magnetic field is created around the electromagnetic locking mechanism 36 that draws surrounding metallic objects towards it. When the coil is de-energized the magnetic field around the electromagnetic locking mechanism dissipates.

Elongated shiftable links 40 are arranged longitudinally and adjacent to the electromagnetic locking mechanism 36 and are operable when the coil is energized and de-energized. An armature 42 is arranged longitudinally and adjacent to the electromagnetic locking mechanism 36 and is movable within the push bar locking mechanism 30 when the electromagnetic locking mechanism is energized and de-energized. When the coil is energized the magnetic field draws the armature toward the electromagnetic locking mechanism 36 and when the coil is de-energized the armature can move toward the base of the bar frame 34. As more fully described below this action of the armature is such that the push bar locking mechanism 30 is prevented from opening its door when the electromagnetic locking mechanism 36 is energized and conversely, the push bar locking mechanism 30 is allowed to open its door when the electromagnetic locking mechanism 30 is de-energized.

According to the present invention, the push bar locking mechanism includes a separation mechanism which overcomes the residual magnetism of the electromagnetic locking mechanism 36 when it is de-energized to permit almost immediate opening of the door. The separation mechanism can comprise one or more spring biased elements (described below) that engage an armature 42 and cause separation between the armature 42 and the electromagnetic locking mechanism 36 after it is de-energized. Without the separation force provided by the springs biased elements, the armature 42 can remain in temporary contact with the electromagnetic lock mechanism 36 by residual magnetism. This can temporarily preclude opening of the door, at least until such time as the residual magnetism has dissipated.

An elongated first lock link 44, having each of its ends turned up to approximately 90 degrees, is arranged adjacent to the armature 42 and between the base frame 34 and the armature 42. The armature 42 is arranged between the turned up ends of the link 44 and the ends of link 44 are connected to a respective one of first and second spring type actuators 46a, 46b, preferably to a base 48 on each of the actuators 46a, 46b. An elongated second lock link 50, having at least one end that is turned up to approximately 90 degrees, is also arranged longitudinally within the push bar locking mechanism 30 in alignment with the first lock link 44. The turned up end of the second lock link 50 is connected to the second spring type actuator 46b, also preferably to the actuator base 48.

When a force is applied to the push bar 32 the electromagnetic locking mechanism is de-energized and the armature 42 is pushed away from the electromagnetic locking element 36 by a spring biased element (described below). This action allows the first and second lock links 44, 50 to slide/shift within the push bar locking mechanism 30, which can in turn cause the spring biased bolt to disengage from the door frame so the door can be opened. Pursuant to the present invention, however, the first and second lock links cannot move until such time as there as the electromagnetic locking mechanism 36 is de-energized.

In the embodiment shown in FIG. 2, when the electromagnetic locking mechanism 36 is de-energized, a force applied to the push bar 32 is applied to actuators 46a, 46b, against the action of actuator internal springs (not shown). As the push bar 32 is pushed in toward the bar frame 34, the actuators 46a, 46b compress, which in turn causes each actuator base 48 to slide toward the first end 52 of the push bar locking mechanism 30. This causes the first and second links 44, 50 to slide within and toward the first end 52. As this occurs, the armature 42 is also shifted toward the first end 52.

FIG. 3 shows internal components of the push bar locking mechanism 30 in more detail, including the electromagnetic locking mechanism 36, one of the shiftable links 40, the armature 42 and the first elongated link 44. Different biasing elements can be included that can be arranged in many different ways to bias the armature away from the electromagnetic locking mechanism. In one embodiment according to the present invention, and spring biasing element 54 is arranged internal to the electromagnetic locking mechanism 36, within an opening 56 and applies a spring separation force to the armature 42.

As shown in FIG. 3, the electromagnetic locking mechanism 36 is energized such that the armature 42 is drawn against the electromagnetic locking mechanism 36, which compresses the spring biasing element 40. The armature further comprises an armature lip 58 and the electromagnetic locking mechanism 36 further comprises a stop 60, with an indent 62 provided at the end of the electromagnetic locking mechanism 36 adjacent to the stop 60. When the electromagnetic locking mechanism 36 is energized, the armature lip 58 is drawn into the indent 62 such that movement of the armature 42, relative to the electromagnetic locking mechanism 36, is blocked.

The first elongated link 44 comprises a link lip 64, with the armature 42 arranged adjacent to the first elongated link 44, between the link lip 64 and one of the turned up ends of the elongated link 44. When movement of the armature 42 is blocked, movement of the elongated link 44 is also blocked by the link lip 64 and the turned up end butting against the armature 42. As more fully described below, when the electromagnetic locking mechanism 36 is de-energized, the spring biased element 54 causes the armature 42 to separate from the electromagnetic locking element which permits movement of the first elongated link 44.

FIGS. 4-6, show movement of the armature 42 relative to the electromagnetic locking element 36, as the electromagnetic locking element is energized and de-energized. The first elongated link 44 and link lip 64 are shown. The armature lip 58, stop 60, and indent 62 are not shown to simplify the description, but are shown in more detail in FIGS. 7-9. It should be understood that many different arrangements can be used to prevent movement of the first elongated link 44 when the electromagnetic locking mechanism 36 is energized, and the link 58, stop 60 and indent 62 illustrates only one embodiment pursuant to the present invention. In FIG. 4, the electromagnetic locking mechanism 36 is not energized, and the spring biasing element 54 separates the armature from the electromagnetic locking mechanism 36. In FIG. 5, the electromagnetic locking mechanism 36 is energized, drawing the armature 42 against it and compresses the spring within the opening 56. In FIG. 6, the electromagnetic locking mechanism 36 is again de-energized and the armature is again separated from the electromagnetic locking mechanism under the bias of the spring biasing element 54. The spring biasing element is strong enough to overcome residual magnetism of the electromagnetic locking mechanism 36, allowing for near immediate separation of the armature 42 and electromagnetic locking mechanism 36, and near immediate operation of the push bar locking mechanism 30 and opening of the door.

FIGS. 7-9 show in more detail the movement of the armature 42 relative to the electromagnetic locking element 36, as the electromagnetic locking element 36 is energized and de-energized. Again the first elongated link 44 and its link lip 64 are shown and in each of FIGS. 7-9, the spring biasing element 54, opening 56, armature lip 58, stop 60, indent 62 and link lip 64 are shown in more detail. In FIG. 7, the electromagnetic locking mechanism is not energized and the spring biasing element 54 extends from the electromagnetic locking mechanism 36, causing a separation with the armature 42. This in turn causes the armature lip 58 to move out of the indent 62 such that the armature 42 can move relative to the electromagnetic locking mechanism 36. This in turn allows the first elongated link 44 to move in response to the first and second spring type actuators 46a, 46b, which operate in response to movement of the push bar 32 (all shown in FIG. 2).

FIG. 8 shows the electromagnetic locking mechanism when it is energized with the armature 42 drawn toward it and the spring biasing element 54 compressed within opening 56. As described above, this causes this armature lip 58 to be drawn into the indent 62 such that the armature is blocked from longitudinal movement, which in turn blocks the first elongated link from longitudinal movement by the first and second actuators 46a, 46b. Accordingly, the push bar 32 is blocked from opening the door until the electromagnetic locking mechanism is de-energized.

FIG. 9 again shows the electromagnetic locking mechanism 36 when it is de-energized, with the spring biasing element 54 separating the armature 42 and electromagnetic locking mechanism 36. This in turn forces the link lip 64 out of the indent 62 to allow movement of the armature 42 and the first elongated link 44. FIG. 9 shows the first elongated link 44 and armature 42 after movement of the first elongated link 44 by the first and second actuators 46a, 46. The link lip 64 is out of alignment with the indent 62 and this movement can cause the spring biased bolt 18 to retract from the bolt receiving opening 20 to allow the door 12 to open (see FIG. 1). This present invention thereby provides a unique and novel push bar door mechanism with rapid unlocking.

It is understood that many different mechanisms can be used for the spring biasing element in push bar locking mechanisms according to the present invention. The spring biasing element 54 shown in FIGS. 4-9 generally comprises a coil spring with a inflexible ball of ceramic, metal, plastic or the like on top of the spring. The diameter of the opening 56 is slightly smaller than the diameter of the inflexible ball, such that the ball protrudes from the opening in response to bias of the coil spring. Another embodiment of a spring biasing element according to the present invention comprises a resilient, flexible, compressible, elastomeric plug of rubber or plastic seated in the opening 56. A portion of the plug extends from the opening and is compressible back into it. A third embodiment according to the present invention comprises a resilient compressible, elastomeric plug at the end of a coil spring, with the spring extending the plug from the opening. A fourth embodiment according to the present invention comprises a coil spring in the opening 56 that can extend from the opening.

Although the present invention has been described in considerable detail with references to certain preferred configurations thereof, other versions are possible. Therefore the spirit and scope of the claims should not be limited to the preferred version contained herein.

We claim:

1. A push bar locking mechanism for locking and unlocking a door, comprising;
a push bar movably arranged integral to a bar frame, such that said push bar can be moved relative to said bar frame to move a door locking mechanism between the locked and unlocked position;
an electromagnetic locking mechanism integral to said push bar; and
an electrical conductor to apply an electrical signal to said electromagnetic locking mechanism to energize said electromagnetic locking element to prevent said push bar from moving said door locking mechanism to the unlocked position.

2. The push bar locking mechanism of claim 1, wherein said electromagnetic locking mechanism is energized or de-energized by said signal from said electrical connector.

3. The push bar locking mechanism of claim 3, wherein said push bar is prevented from moving said door locking mechanism when said electromagnetic locking mechanism is energized and said push bar not prevented from moving said door locking mechanism when said electromagnetic locking mechanism is de-energized.

4. The push bar locking mechanism of claim 3, further comprising a spring biased element arranged to overcome any residual magnetism when said electromagnetic locking mechanism changes from energized to de-energized such that said push bar can almost immediately move said door locking mechanism when said electromagnetic locking mechanism is de-energized.

5. A push bar locking mechanism for locking and unlocking a door, comprising;
a push bar movably arranged integral to a bar frame such that said push bar can be moved relative to said bar frame;
an elongated link integral to said push bar and bar frame, said elongated link movable in response to said push bar movement relative to said bar frame, the movement of said elongated link moving a door locking mechanism between the locked and unlocked position;
an electromagnetic locking mechanism that can be changed between an energized and de-energized state by an electrical signal, wherein said electrical locking mechanism generating a magnetic field when energized; and
an armature in proximity to said electromagnetic locking mechanism and said elongated link, said armature preventing movement of said elongated link when said electromagnetic locking mechanism is energized.

6. The push bar locking mechanism of claim 5, wherein said armature is drawn to and held in place adjacent to said electromagnetic locking mechanism when said locking mechanism is energized.

7. The push bar locking mechanism of claim 5, wherein said armature does not prevent movement of said elongated link when said electromagnetic locking mechanism is energized.

8. The push bar locking mechanism of claim 7, wherein said electromagnetic locking mechanism experiences residual magnetism when changing from its energized to de-energized state, said push bar locking mechanism further comprising a spring biased element operable on said armature and strong enough to overcome said residual magnetism, said spring biased element allowing said elongated link to move said door locking mechanism between the locked and unlocked position almost immediately after said electromagnetic locking mechanism is deactivated.

9. The push bar locking mechanism of claim 8, wherein said electromagnetic mounting mechanism further comprises an opening, said spring biased element arranged within said opening.

10. The push bar locking mechanism of claim 8, wherein said spring biased element comprises a coil spring and inflexible ball.

11. A door system, comprising:
a door mounted within a door frame such that said door is movable between an open and closed position within said door frame;
a spring biased bolt integral to said door and movable between an extended and retracted position;
a bolt receiver opening integral to said door frame and arranged to accept said bolt when it is extended from said door, said bolt and opening cooperating to hold said door in the closed position when said bolt is extended into said opening;
a push bar locking mechanism mounted to said door and is operable to retract said bolt and comprising;
a push bar movably arranged integral to a bar frame, such that said push bar can be moved relative to said bar frame to retract said bolt;
an electromagnetic locking mechanism integral to said push bar; and
an electrical conductor to apply an electrical signal to said electromagnetic locking mechanism to prevent said push bar from moving said door locking mechanism to the unlocked position.

12. The door system of claim 11, wherein said push bar locking mechanism is mounted horizontally to said door.

13. The door system of claim 11, further comprising an elongated link integral to said push bar and bar frame, said elongated link movable in response to said push bar movement relative to said bar frame, the movement of said elongated link moving said door locking mechanism.

14. The door system of claim 13, further comprising an armature in proximity to said electromagnetic locking mechanism, said electromagnetic locking mechanism being changeable between an energized and de-energized state by said electrical signal, said electrical locking mechanism generating a magnetic field when energized, said armature preventing movement of said elongated link when said electromagnetic locking mechanism is energized.

15. The door system of claim 14, wherein said armature is drawn to and held in place adjacent to said electromagnetic locking mechanism when said locking mechanism is energized.

16. The door system of claim 14, wherein said armature does not prevent movement of said elongated link when said electromagnetic locking mechanism is energized.

17. The door system of claim 14, wherein said electromagnetic locking mechanism experiences residual magnetism when changing from its energized to de-energized state, said push bar locking mechanism further comprising a spring biased element operable on said armature and strong enough to overcome said residual magnetism, said spring biased element allowing said elongated link to move said door locking mechanism between the locked and unlocked position almost immediately after said electromagnetic locking mechanism is deactivated.

18. The door system of claim 17, wherein said electromagnetic mounting mechanism further comprises an opening, said spring biased element arranged within said opening.

19. The door system of claim 14, wherein said spring biased element comprises a spring and inflexible ball.
